(19) United States
(12) Patent Application Publication
(10) Pub. No.: US 2024/0388224 A1
(43) Pub. Date: Nov. 21, 2024

(54) ENERGY HARVESTING DEVICE

(71) Applicant: CONSEJO SUPERIOR DE INVESTIGACIONES CIENTIFICAS (CSIC), Madrid (ES)

(72) Inventors: Ghaffarinejad ALI, Sevilla (ES); Barranco Quero ANGEL, Sevilla (ES); García Casas XAVIER, Sevilla (ES); Borras Martos ANA ISABEL, Sevilla (ES); Sánchez Valencia JUAN RAMÓN, Sevilla (ES)

(21) Appl. No.: 18/687,186

(22) PCT Filed: Aug. 29, 2022
(86) PCT No.: PCT/EP2022/073950

§ 371 Date: Feb. 27, 2024

(30) Foreign Application Priority Data
Aug. 27, 2021 (EP) 21382786.8

(51) Int. Cl. H02N 1/04

(52) U.S. Cl. CPC H02N 1/04

(57) ABSTRACT

An energy harvesting device for obtaining instantaneous energy from drops without needing of moving the drops along the device, in a reduced scale and combinable with other types of harvesting devices. the energy harvesting device comprising one or more triboelectric generators comprising a bottom electrode. a friction or triboelectric element placed over the bottom electrode, and at least two top exposed electrodes electrically connected placed over the triboelectric element and defining at least one gap between them. exposing the triboelectric element to the external environment so that on contacting a drop of liquid makes an electrical connection between the top electrodes varying instantaneously (microseconds range) the capacitance of the triboelectric generators.

### OBJECT OF THE INVENTION

The invention is in the field of renewable energies, and more specifically is related to an energy harvesting device. The invention is aimed to obtain electric energy from droplets and liquids by using a triboelectric configuration working from micrometric to sub millimetric dimensions as a function of the droplet size distribution.

One object of the present invention is an energy harvesting device having a new configuration for obtaining energy from drops and liquids instantaneously in a reduced scale.

### BACKGROUND ART

The field of harvesting ambient environmental energy has gained great interest in the last decade as a response to the ever-increasing demand to find environmentally friendly alternatives to the global dependence on fossil fuels.

One of the applications of the field of energy harvesting is to provide electric power for low-power electronic and wireless devices to reduce their dependency on (rechargeable) batteries. The main motive of the design and fabrication of energy harvesting devices is to develop a system that is capable of converting ambient and free energy from the surrounding environment of the targeted electronic device. The generated energy can directly power up the target device or it can be stored in an energy storage unit for later use.

The use of triboelectric effect for drop energy harvesting was first settled by the group of ZL Wang which presented the combined mechanism of contact electrification and charge induction to explain the voltage generated upon the contact of a sliding water drop and the surface of a triboelectric layer.

The current is generated by the contact and movement of the following drops and flows through a single electrode buried below the triboelectric layer.

This same mechanism has been exploited and extended to the presence of two buried electrodes. The contact electrification and charge induction mechanisms have been exploited to harvest from falling drops and also from liquids movement within microtubes and hoses.

Some developments combine the triboelectric energy generation with solar light harvesting by emplacing a transparent drop energy harvester on top of a silicon solar cell. A variation of said concept combines two different triboelectric layers and sliding droplet moving from one side to the other.

Another approach is the use of a top exposed electrode on top of the triboelectric layer in such a way that the triboelectric layer is sandwiched between the top metal thin electrode and a bottom extended one or solely using a thin top electrode.

Also, there are some developments using a single electrode in the form of a needle going through the triboelectric layer.

Document US2019280620 discloses an apparatus and method for collecting ambient energy. The apparatus comprises charge storage devices and switching circuits, configured to cyclically alter the connection between the charge storage devices between a series state and a parallel state. Electrically conductive elements can include electrically conductive liquid droplets of materials such as water or mercury. In the device, a droplet of conductive liquid can make electrical contact with a parallel metallic contact or with a series of metallic contact but not with both contacts at the same time. Charge storage devices include a capacitance that varies in response to the reception of ambient energy. The simultaneous alteration of the relative capacitance and circuit configuration results in an exponential growth of the collected energy.

Also, document WO15154693 presents a triboelectric nanogenerator that collects mechanical energy from a liquid. The triboelectric nanogenerator comprises an electricity generation component on an insulating substrate and a friction layer that covers the electricity generation component. The electricity generating component is constituted by two layers of electrodes arranged separately along a fluctuation direction of the liquid and electrically connected to each other. When the liquid fluctuates or flows, friction occurs between it and the friction layer, so that the surface of the friction layer in contact with the liquid carries charges. As the liquid fluctuates or flows, the charges on the surfaces of the friction layer corresponding to the two electrode layers are successively shielded by ions in the liquid so that an induced charge flow occurs between the two electrode layers.

Document CN105099260 describes a flowing liquid-based composite power generator. The power generator can be used as a self-powered sensor to detect the concentration of ethanol in a solution. The power generator is mainly formed by stacking an electrostatic induction power generation set and a contact friction power generation set. When a liquid, such as rainwater and water, in the environment touches the power generator, the static electricity from the water can make the electrostatic induction power generation set work and produce electricity. The mechanical energy of flowing water can make the contact friction power generator work and produce electricity at the same time and could be enhanced by arranging the power generator in a sloped position.

Document EP3171416A1 describes a liquid energy conversion apparatus employing a laminate electrode structure formed by a substrate, a bottom electrode, and a top electrode sandwiched in what is called an energy conversion layer. In this invention, the conversion mechanism driven by the contact of the top electrodes with a liquid is compatible with exposed and buried electrodes. Miniaturization of the device is carried out by vertical electrode structuration and the power conversion can be enhanced by multiplying the bottom and top electrodes. In the claimed typical embodiment of the invention, the bottom and top electrodes present extended dimensions larger than the drops' contact areas. The embodiment of the invention generates upon contact with a liquid drop an alternating current signal with positive and negative peaks lasting tens of milliseconds.

However, there is yet a need for an improved way of harvesting triboelectric energy from drops and liquids more efficiently. A current technological urgency is to develop liquid energy harvesters able to produce high power density (W/m²) in an instantaneous way (in the order of microseconds) upon contact with droplets or liquid flows.

Documents KR20210004437A and KR20200021659A disclose the possibility of combining a generator capable of harvesting energy from rainwater with other type of generators for producing alternating electrical current. In particular, there are disclosed configuration with solar cells by using transparent materials, which allow the sun light to reach the solar cells.

Also, the application of the energy harvesters in a global framework for renewable energy production requires high compatibility of the energy harvesters' architecture and materials with other energy conversion or harvesting systems.

### DESCRIPTION OF THE INVENTION

The invention is intended to harvest or convert the energy of falling droplets or moving liquids on the surface of a friction or triboelectric element, layer, foil, coating, bulk or plate, which will be referred to as friction or triboelectric element, by using the triboelectric effect.

The objective of the invention is to harvest energy coming from the fall and/or movement of liquid drops or liquid flow on a surface to produce electric energy. Therefore, an energy harvesting device is presented to generate electric energy based on instantaneous capacitance variation that occurs when a drop or a conductive liquid contacts two thin electrodes on the surface of the triboelectric element, acting as an insulator material in a capacitor, thus, changing the effective area of the top electrodes. The invention can generate instantaneous electric power from any form and type of polar, conductive or partially conductive liquid droplets and flows ranging from rainwater and chemical compounds to human blood. Therefore, the invention can be placed outdoor to harvest from rain, inside of hoses, tubes or microfluidic systems and also as a component of biomedical implants.

Also, the energy harvesting device of the invention provides multiple advantages. On the one hand, this would make possible the energy harvesting from continuous or high-frequency contact with drops or liquid flows as happening in scenarios like hoses, sprinkles, irrigation, and microfluidic devices and from the impact of droplets from natural or artificial fogs or mists. On the other hand, it would allow to boost the generation of power by relatively low-frequency events, such as the impact of droplets during rainfall to allow for the conversion of the leftover kinetic energy of the bouncing drop by a nearby energy harvester.

Another advantage of the invention is the compatibility of the energy harvester architecture and materials with production by high yield fabrication technologies providing the compatibility of standardized fabrication protocols such as CMOS-compatible, thin-film technology, printed electronics, etc.

The energy harvesting device of the invention comprises one or more triboelectric generators. Each triboelectric generator comprises a bottom electrode, at least one friction or triboelectric element placed over the bottom electrode, and at least two exposed (i.e. non-buried) top electrodes electrically connected placed over the triboelectric element and defining at least one gap between them, being said top electrodes preferably smaller than the bottom electrode and the top and bottom electrodes being at least 5 times smaller than the contacting and spreading area of the droplet or liquid when reaching the triboelectric element, such that the contact area of the droplet or liquid covers at least the two exposed electrodes.

Therefore, the triboelectric or friction layer/foil/plate is exposed to the external environment so that upon the contacting of a liquid with the top electrodes make an electrical connection varying the capacitance of the device, which depends on the size of the bottom and top electrodes.

The energy generated by the energy harvesting device depends on the rate of the change of effective overlapping area between top and bottom electrodes, capacitance between the top and bottom electrodes, and the density of electrical charges stored in the triboelectric element.

The energy harvesting device of the invention could be scalable to larger areas by integration of arrays of devices to achieve energy extraction from a sequence of different spatially separated droplets and also with the possibility of extracting energy from each of these droplets repeatedly from multiple bounces or contacts on the device surface.

The energy harvesting device of the invention could further comprise one or more substrates placed under the triboelectric generators, which could be flexible or non-flat, among others. The energy harvesting device of the invention can also work as a self-supported system without the need for a substrate.

Regarding the materials, the electrodes could be manufactured, without excluding other formulations, using thin metal layers, metallic thin films, transparent conducting oxides and polymers, graphene or metal meshes and could be manufactured having a round, triangular or rectangle shape, among others. Deposition techniques such as physical vapor deposition, chemical vapor deposition, wet chemistry methodologies, lithography and printing can be cited as examples of the available methodologies to produce such films.

The active area of the energy harvesting device of the invention is not limited in shape but it is intended to be much smaller than the contact area of the droplet or the liquid flow. The size of each triboelectric generator can range preferably from the micrometre to sub millimetre scale to harvest the kinetic energy in an instantaneous way, preferably, generating a voltage peak in the microsecond to millisecond range. The invention can be multiplied in number in order to cover larger areas.

A defining feature of this invention is that the minimum size of the device is determined by the size of the droplet impinging on its surface, for droplets in the size of submillimiters to centimeters. Such that it is possible to design a fully functional array of inventions covering a total area similar to that of the impact area of a typical water droplet on a given surface. Such an array of inventions could already extract the maximum energy from individual direct impacts of droplets on its surface.

The triboelectric elements could be rigid or flexible and must be compatible with the injection or generation of electrical charge on its surface, positively or negatively, with the help of charge injection techniques, or it is charged by natural effects, such as natural sources, or upon contact with the liquid itself.

The energy harvesting device of the invention can work as a single triboelectric generator to produce electric energy from falling raindrops or any fluid flow or can integrate a large number of triboelectric generators close together in micrometre to sub-millimetre dimensions for energy harvesting by several energy harvesters from a single drop or from several hundred (or more) of droplets at the same time.

For obtaining more energy, a high number of triboelectric generators could be manufactured using CMOS (complementary metal-oxide semiconductors), MEMS (microelectromechanical systems), IC (Integrated Circuit), PCB (Printed Circuit Boards) technologies and others such as soft-lithography, printing, and laser patterning methods.

An array of triboelectric generators functions similar to a CCD or CMOS image sensors. In this case, each triboelectric generator can convert the energy of the incoming raindrop or fluid flow to induce electrons to generate electric power.

The energy harvesting device of the invention can also be combined with other energy collection and harvesting mechanisms such as photovoltaic and thermosolar cells, thermoelectric, pyroelectric, piezoelectric and/or alternative triboelectric configurations. Therefore, other types of energy harvesters, such as, at least one photovoltaic or thermosolar cell and/or at least one thermoelectric, pyroelectric, piezoelectric or triboelectric energy harvester could be fabricated sequentially one after another, co-fabricated or connected to the invention, scavenging energy from solar and light sources, temperature gradients or fluctuations and kinetic energy.

In case that the energy harvester is combined with other energy harvesting devices such as solar cells, the triboelectric generators and the substrates could be made of transparent materials to allow the light to reach the energy harvesters. Some selected examples of these materials, without restriction to others, are conducting oxides and conducting polymers for the electrodes and thin layers of polymers or oxides for the triboelectric element. The substrate could be placed below the triboelectric generators or all the energy harvesting devices.

For aiding the fluid to move along the energy harvesting device, the triboelectric generators could be arranged in a sloped position with respect to a horizontal plane or present a hydrophobic surface or a surface with a certain slippery behaviour. In the case wherein the surface is hydrophobic or slippery, the output voltage would be a positive voltage peak which produces DC current pulses.

The energy harvesting device of the invention could also comprise a power management unit, connected to the triboelectric generators and the at least one photovoltaic or thermosolar cell and/or at least one thermoelectric, pyroelectric, piezoelectric or a different triboelectric energy harvester, to manage the storage and/or use of energy obtained.

The triboelectric or friction elements can be manufactured, without excluding other formulations, employing polymer plates, foils or thin films, metal oxides, organic or inorganic semiconductors in the form of plates, foils or thin films, 2D layered materials, composite and hybrid materials. The surface of the triboelectric element also could be chemically functionalized to control the liquid contact angle, enhance the electrical charging capability or improve its durability.

The triboelectric generator of the invention produces energy from a triboelectric effect by varying the capacitance, Cᵥₐᵣ, of the triboelectric generator upon interaction with the liquid. When the liquid makes a contact with the exposed electrodes, electrically connected, the effective overlapping area Aₑ of the capacitor suddenly increases to Aₑ^{Max} which makes the total capacitance of the device to increase to Cₘₐₓ instantaneously.

Before the drop reaches the top electrodes, the effective overlapping area is at minimum value of Aₑ^{Min}=2L₁W and the capacitance is

$${C}_{min} = {ε}_{0} {ε}_{r} \frac{{A}_{e}^{Min}}{h} .$$

L₁ and W are the dimensions of each top electrode, considering the same dimensions for both, ε₀ and εᵣ are the vacuum dielectric permittivity and relative permittivity of the triboelectric element correspondingly and h is the thickness of the triboelectric element, which in this case is a layer, assuming only one layer exists between bottom and top electrodes.

Between the contact and non-contacting states, there is a sudden capacitive variation defined by the ratio r between Cₘₐₓ (after the drop contact) and Cₘᵢₙ (before drop contact).

$${C}_{min} = {ε}_{0} {ε}_{r} \frac{{A}_{e}^{Min}}{h} \qquad Eq . 1$$

$${C}_{max} = {ε}_{0} {ε}_{r} \frac{{A}_{e}^{Max}}{h} \qquad Eq . 2$$

$$r = \frac{{C}_{max}}{{C}_{min}} = \frac{{A}_{e}^{Max}}{{A}_{e}^{Min}} \qquad Eq . 3$$

The dissipated power in a load (R_{L}) connected to the device can be approximated for small areas as considered herein as:

$$P = {k}^{2} {{V}_{var}^{2} ( \frac{{dA}_{e} ( t )}{dt} )}^{2} \qquad Eq . 4$$

wherein Vᵥₐᵣ is the variable output voltage and k is a constant defined as:

$$k = ( \frac{\sqrt{{R}_{L}} {C}_{0}}{S} ) \qquad Eq . 5$$

Where C₀ is the constant capacitance

$${C}_{0} = \frac{S {ε}_{0} {ε}_{r}}{h}$$

due to the thickness (h) of the triboelectric element and the surface(S) of the bottom electrode.

Therefore, the faster the change of Aₑ(t) in time is, the higher is the power delivered to the load.

The invention is applicable to solve a critical issue of sources of renewable electric energy which by definition are intermittent, free and random. In this regard, multisource energy harvesters, as explained in the case of the energy harvesting device able to convert from multiple drop impacts is a solution for providing an instantaneous and more constant flow of energy.

The key differencing characteristics of the present invention are:
1—A new mechanism for energy harvesting from falling or moving droplets or drops in a fluid based on a sudden capacitance variation. The capacitance variation occurs as the result of instantaneous contact of a single drop with the top exposed electrodes electrically connected, changing its effective area. The liquid must be polar, conductive or partially conductive, i.e. non-polar liquids must be discarded. Therefore, there is no need for the drop to slip or move over a certain distance before contacting the electrodes which helps in reducing the area of the device, preferably, having an active area dimension of micrometre to sub millimetre scale.
2—The condition for the active dimension of the micrometre to sub millimetre scale, typically much smaller than the contact area of a falling drop (as in rainwater) or a liquid flow, provides for the instantaneous change of capacitance in the range from microseconds to milliseconds for power generation.
3—Providing the first triboelectric nanogenerator that can be fabricated with sub millimetre or micrometre dimensions using standard CMOS, soft-lithography, printing or laser patterning technologies.
4—Production of a highly integrated array of inventions using IC, CMOS, MEMS CCD technology, soft-lithography, printing, laser patterning, roll-to-roll processing, or other high yield manufacturing techniques. The integrated array can be made in combination with organic, polymeric, inorganic, hybrid, flexible, and transparent triboelectric elements.
5—Harvesting energy from free-falling or moving drops (including rain, droplets moving in pipes, microfluidic channels, human veins, water and other liquids, including complex fluids such as blood) and without the need for external movement or vibration.
6—Straightforward compatibility with other energy harvesters and energy converting systems, like alternative nanogenerators, thermoelectric generators, solar cells, etc.
7—As a result of its principle of action, the device can be constructed using highly hydrophobic and slippery surfaces to deliver direct current (DC) pulses. The DC power generated depends on the frequency of incidence of the droplets on its surface and the impact energy.

### DESCRIPTION OF THE DRAWINGS

FIG. 1A. shows a schematic view of a first preferred embodiment of the energy harvesting device of the invention comprising a substrate, and FIG. 1B shows a schematic view of the first preferred embodiment of the energy harvesting device of the invention without the substrate.

FIG. 2. shows a schematic view of the first preferred embodiment of the energy harvesting device of the invention with a drop being deposited over the device.

FIG. 3. shows a schematic view of a second preferred embodiment of the energy harvesting device of the invention comprising a plurality of triboelectric generators.

FIG. 4. shows a schematic view of an array of triboelectric as an ordered array of inventions.

FIG. 5. shows a schematic view of the second preferred embodiment of the energy harvesting device of the invention where each drop being deposited over a number of triboelectric generators.

FIG. 6. shows a schematic view of the second preferred embodiment of the energy harvesting device of the invention having shared electrodes and/or substrates.

FIG. 7. shows a schematic view of a third preferred embodiment of the energy harvesting device of the invention comprising other type of energy harvesters to address the potential for multisource energy harvesting. FIG. 7C shows the schematic view where all the energy harvesters are located on top of the substrate. FIG. 7A shows the schematic view where the invention is located on top of the substrate and the rest of the harvesters below the substrate. FIG. 7B shows the combination of the invention with other energy harvesters without the need of a substrate

FIG. 8. shows a schematic view of the third preferred embodiment of the energy harvesting device of the invention comprising other type of energy harvesters and sharing electrodes, substrates and/or the other types of energy harvesters.

FIG. 9A shows an embodiment of the invention fabricated using silver sub millimetre electrodes and a fluorinated polymer as triboelectric element. FIG. 9B shows a graph of the output voltage produced by the energy harvesting device using rainwater.

FIG. 10A presents an embodiment of the invention for a 2×1 array fabricated using silver sub millimetre electrodes and a fluorinated polymer as a triboelectric element. FIG. 10B shows the instantaneous DC peak voltage generated by each of the inventions contacted by a single raindrop.

FIG. 11 presents the peak output voltage for rainwater for a freshly charge surface of the invention.

### PREFERRED EMBODIMENTS OF THE INVENTION

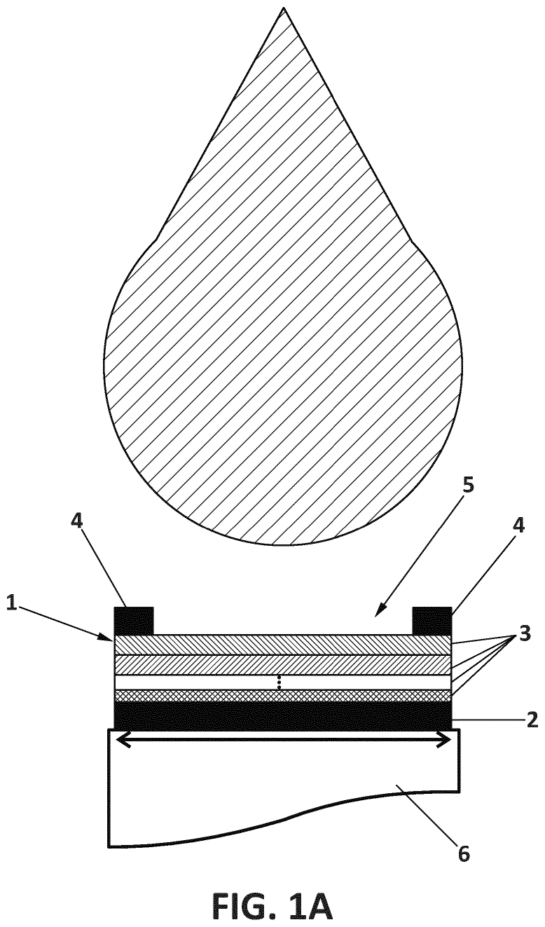

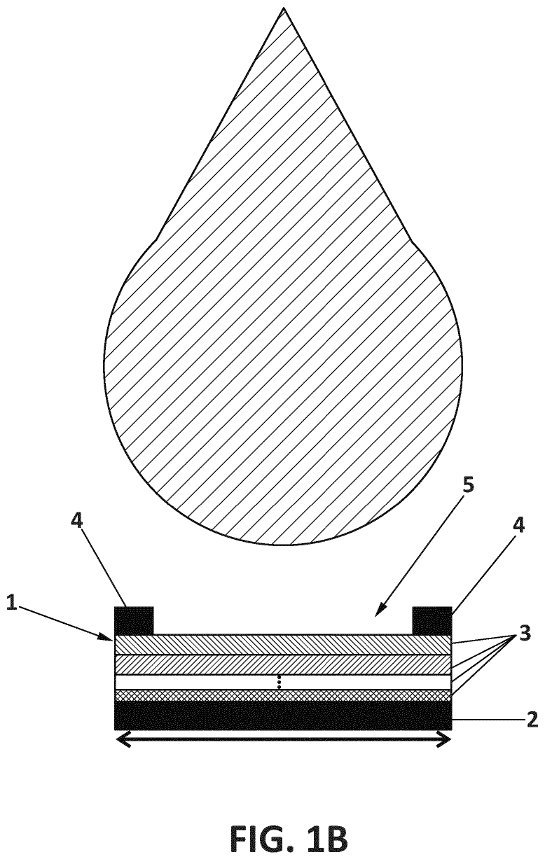

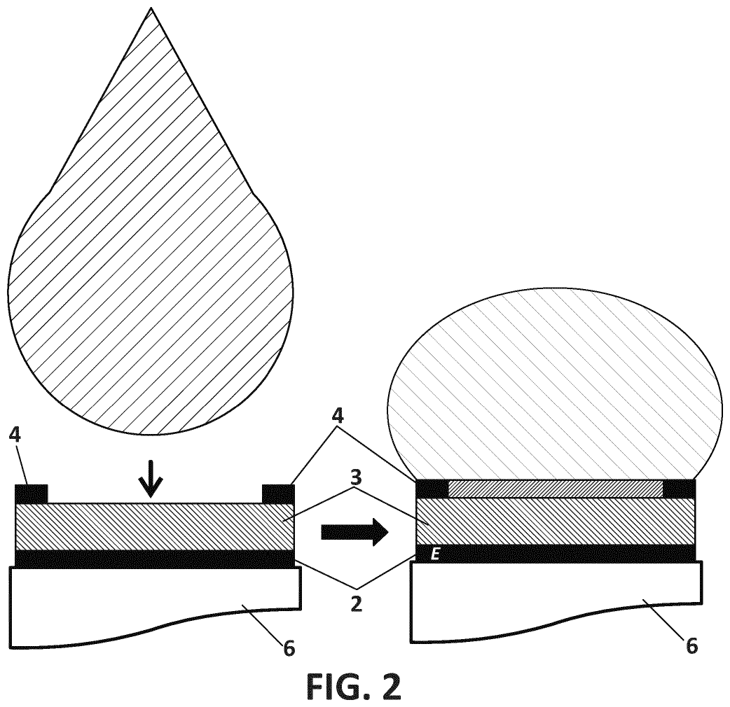

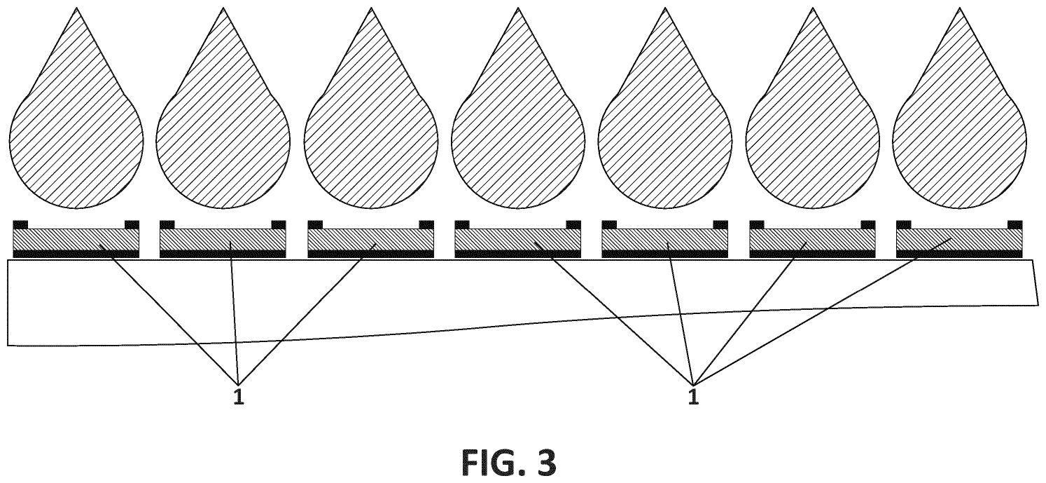

A first preferred embodiment of the invention is shown in FIGS. 1A, 1B and 2 showing an energy harvesting device comprising a single triboelectric generator (1). The triboelectric generator (1), comprises in turn, two exposed top electrodes (4) electrically connected and a bottom electrode (2) having dimensions ranging from a few micrometres to a few hundreds of micrometres. Top and bottom electrodes (2, 4) can vary in composition, shape, length, thickness and distance to harvest or detect drops of different sizes.

The bottom electrode (2), in this case, is placed on a substrate (6) over a certain area. On the bottom electrode (2), one or several friction elements (3) are disposed and designed to make contact with the liquid. The top electrodes (4) are placed over the friction elements (3), each one with a certain area always smaller than the bottom electrode area and much smaller than the contact or spreading area of the drop or liquid with the triboelectric element.

The triboelectric elements (3) need to be charged negatively or positively. This charge can be generated either by natural sources as the constant friction of the water drops, the flow of liquids, the wind or with the help of charge injection techniques.

From the material point of view, friction elements (3) can be organic, inorganic or hybrid, thin films, foils or plates. With respect to conductivity, friction elements (3) can be insulators or semiconductors.

Dimension of each friction element (3) such as thickness, width, length and area can arrange from micrometre to sub millimetre scale.

Electrodes (2, 4) can be organic, inorganic, hybrid, semiconducting or metallic. Preferably, the electrodes (2, 4) are manufactured from conductive materials that can be metal films or transparent systems such as transparent conducting oxides or alternative conducting materials as conducting polymers, graphene, metal meshes and other materials formulations that comply with the electrical and optical requirements.

The invention could be manufactured as a self-standing triboelectric generator (1), as shown in FIG. 1B, or can be manufactured on any kind of support, such as flexible and non-flat substrates (6), as shown in FIG. 1A.

The triboelectric element (3) can be charged and could have a determined wetting contact angle with the targeted liquid or fluid. Thus, in the case of water it is preferable that the surface presents a high contact angle and low roll-off-angle to facilitate the movement of the drops on the surface and also to favour multiple droplet bounces so that each droplet can generate multiple current peaks before leaving the surface of the device.

The angle between the friction element (3) and the horizontal line could be greater or equal to 0°, thus, allowing the drops to move along the triboelectric elements (3) after the interaction with the top electrodes (4).

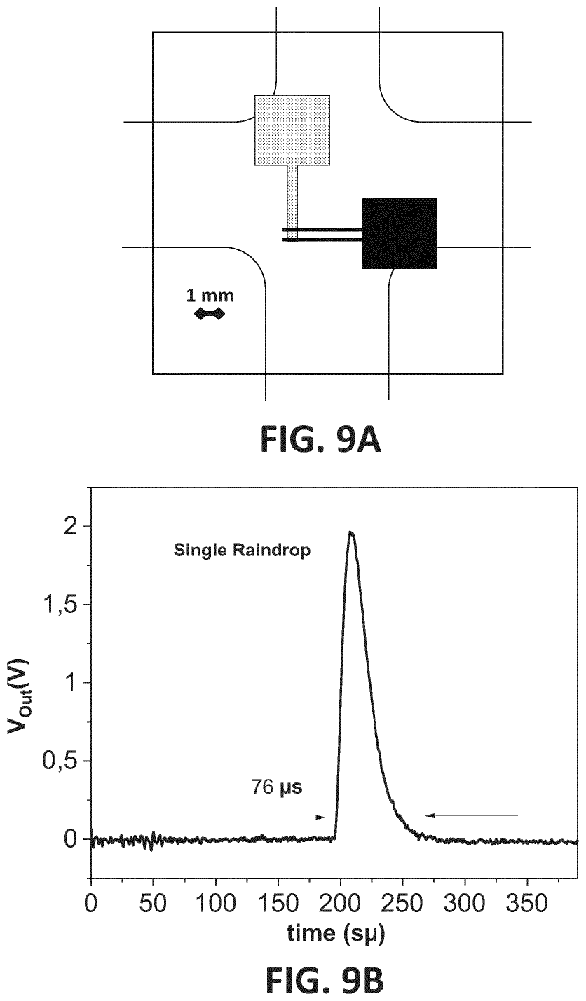

In an example of the invention, shown in FIG. 9A, the triboelectric element (3) is produced with a triboelectric film of PFA, negatively charged by an electron beam and with an active area of 0.81 mm². Electrodes (2, 4) have been fabricated through a shadow mask by physical vapor deposition of silver. In this specific embodiment, the measured harvested energy from a single raindrop can be more than 61.5 pW, and the peak instantaneous power density of the device is 76 W/m².

Since the output voltage of the invention in such an example is not a bipolar signal, there is no need for using rectifiers to make it a direct signal. However, for achieving better efficiency, the energy produced by the invention can be managed by a power management circuit such as a half wave rectifier, full wave rectifier, buck converter, boost converter or any other designed circuit configuration. The managed energy can be stored in a rechargeable battery, capacitor or supercapacitor.

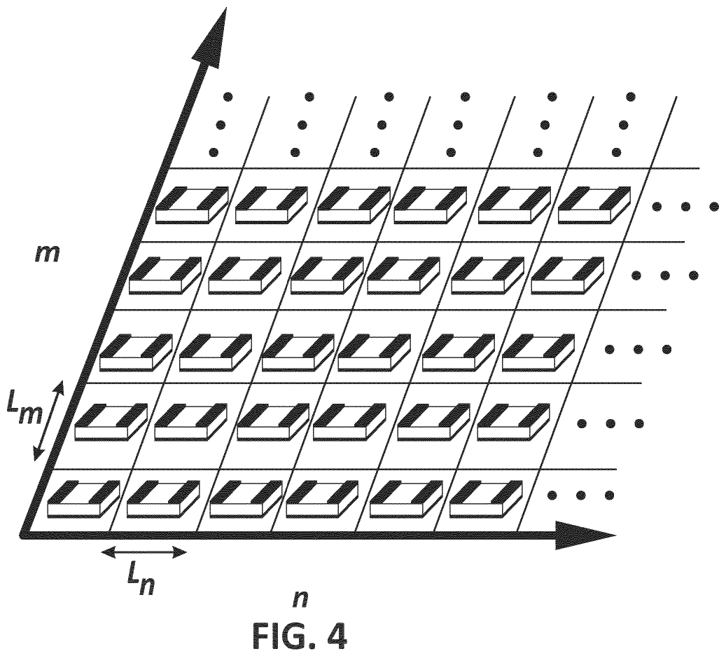

In a second preferred embodiment, a set of triboelectric generators (1) are arranged to form an array or an irregular distribution as shown in FIG. 4

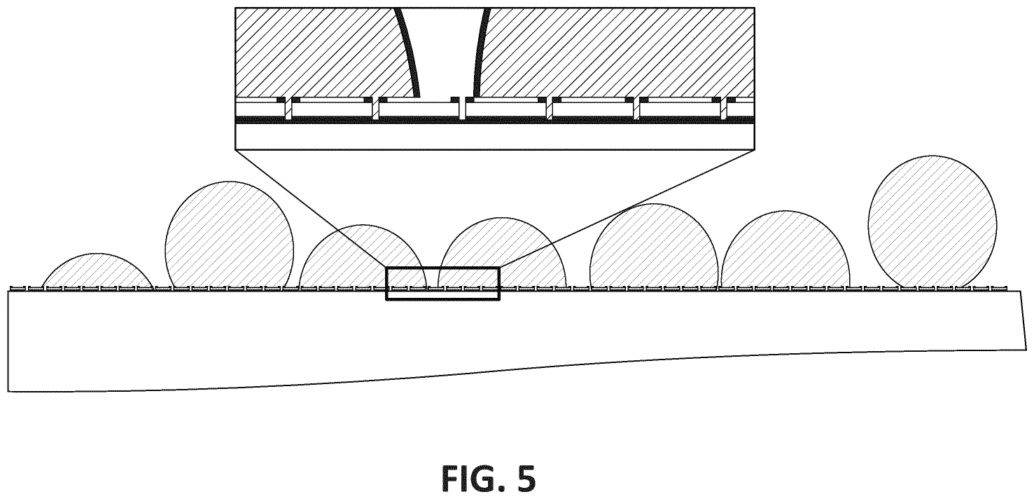

In this embodiment, the array of triboelectric generators (1) can harvest energy from multiple raindrops or any fluid flow at the same time. As shown in FIG. 5, the array of triboelectric generators (1) can be manufactured using CMOS, MEMS, IC, soft-lithography, printing and laser patterning technologies in micrometre to sub-millimetre scale to produce a large number of inventions.

In the FIG. 5, every water drop will make contact with several devices at the same time to produce electric energy. This requires scaling down the dimensions of the invention to micrometre to sub millimetre range.

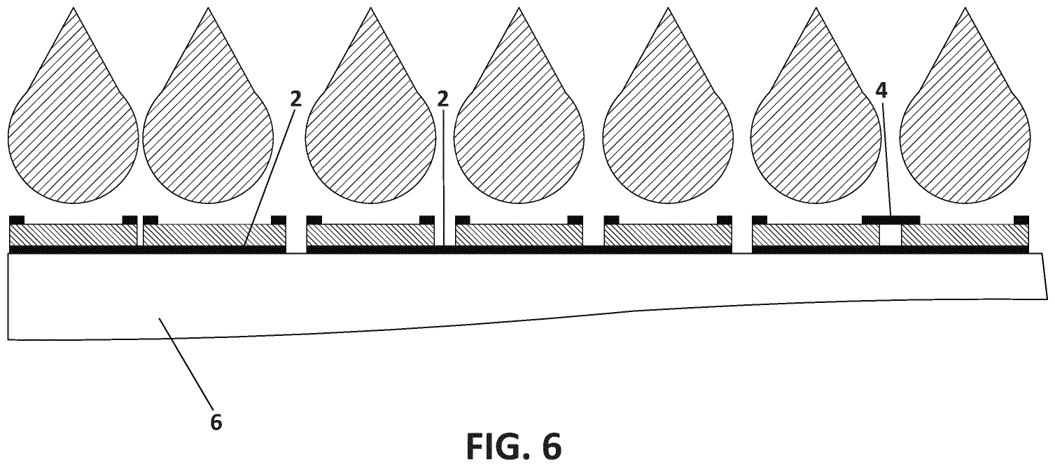

As depicted in FIG. 6, in this embodiment, several triboelectric generators (1) could share the substrate (6) or share bottom or top electrodes (4).

Configuring the triboelectric generators (1) in micrometre and submillimetre scales as an array or following an irregular distribution provides advantages on the performance of the output power:
A single drop can make contact with several triboelectric generators (1) at the same time and produce larger output power.
A single drop can make contact with different triboelectric generators (1) after sliding or bouncing on the surface and produce larger output power.
Any form of liquid flow that makes a contact with the array will contact several hundreds of triboelectric generators (1) and produce multiple times the power that a single triboelectric generator (1) can generate.

In a third preferred embodiment, the triboelectric generator (1) could be combined with other sources of energy, leading to a multisource and multiphysics energy harvester system.

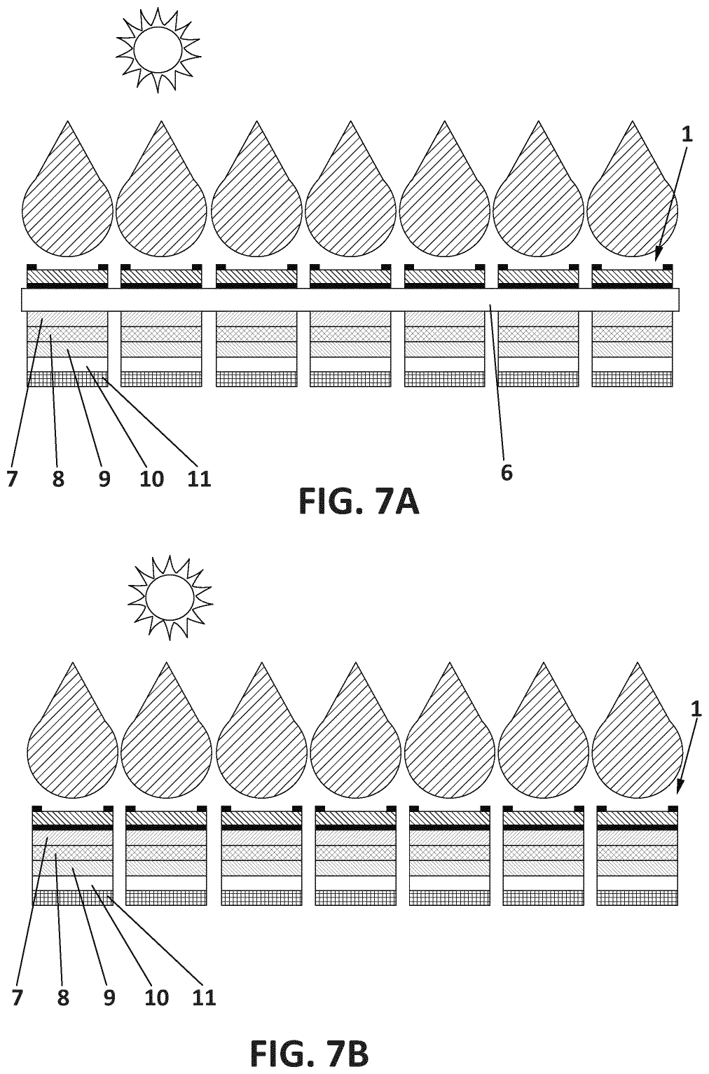

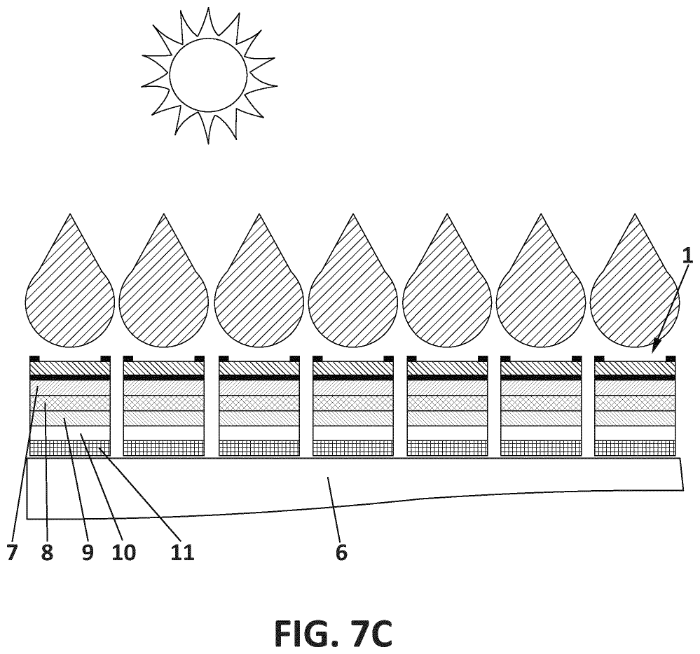

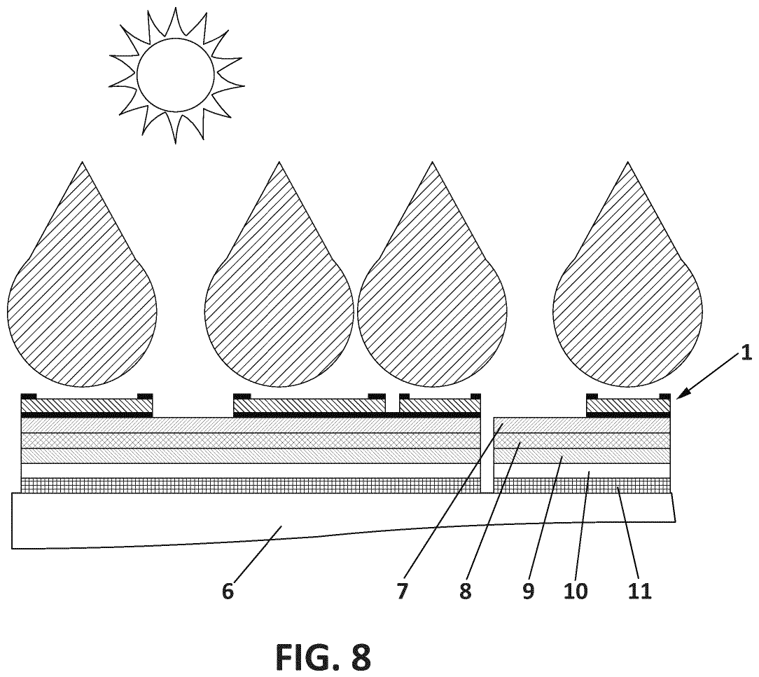

In this case, the multisource and multiphysics energy harvester could be configured as an array of integrated, co-fabricated or co-assembled energy harvesting devices, as shown in FIGS. 7 and 8. FIG. 7A, B and C shows some of the possible configurations with respect to the substrate as all the energy harvesters emplaced on top of the substrate (FIG. 7C), the invention on top of the substrate and the other energy harvesters below (FIG. 7A) or the complete system working as a self-supported device (FIG. 7B).

Other devices can work based on light energy harvesting (7), thermoelectric (10), pyroelectric (9), piezoelectric (8), and triboelectric (11) power generation.

In the combination with other energy harvesting systems, as in FIGS. 7A, 7B, 7C and 8, the energy harvesting device can be produced entirely on transparent materials, as, for example, transparent conducting oxides as conductive electrodes (2, 4) and thin layers of triboelectric elements as triboelectric polymeric layers or polymeric, hybrid, ceramic or metal oxide thin films (3). This characteristic allows for a direct implementation of the invention on top of solar cells (7) from silicon to thin film technologies, including dye-sensitized and perovskite-based solar cells.

In this case, the system can be coupled to a multisource power management circuit designed especially for the multiphysic energy harvester.

The invention is also fully compatible with the fabrication of flexible materials on flexible supports and non-flat substrates, improving the compatibility with vibration and mechanical deformation harvesters.

The order of placement and number of other energy harvesting layers are selected based on design requirements and targeted application, one example of arrangement is shown in FIGS. 7A, 7B and 7C. The array of energy harvesting devices can include triboelectric generators (1) of different sizes and connections, as shown in FIG. 8.

The FIG. 9A shows an embodiment of the invention fabricated using silver sub millimetre electrodes and a fluorinated polymer as triboelectric element, and FIG. 9B shows a graph presenting the peak output voltage produced by said energy harvesting device using rainwater. Both figures show an example of the method for generating DC current by using the device of the invention. This is an indication of the instantaneous generation of power by the energy harvesting device. As shown the generation of power is represented as a peak in the range of microseconds. Also, FIG. 9A shows the configuration of the top exposed electrodes, which are physically separated in the overlapping area with the triboelectric element but are connected electrically at metal pads used to make contacts.

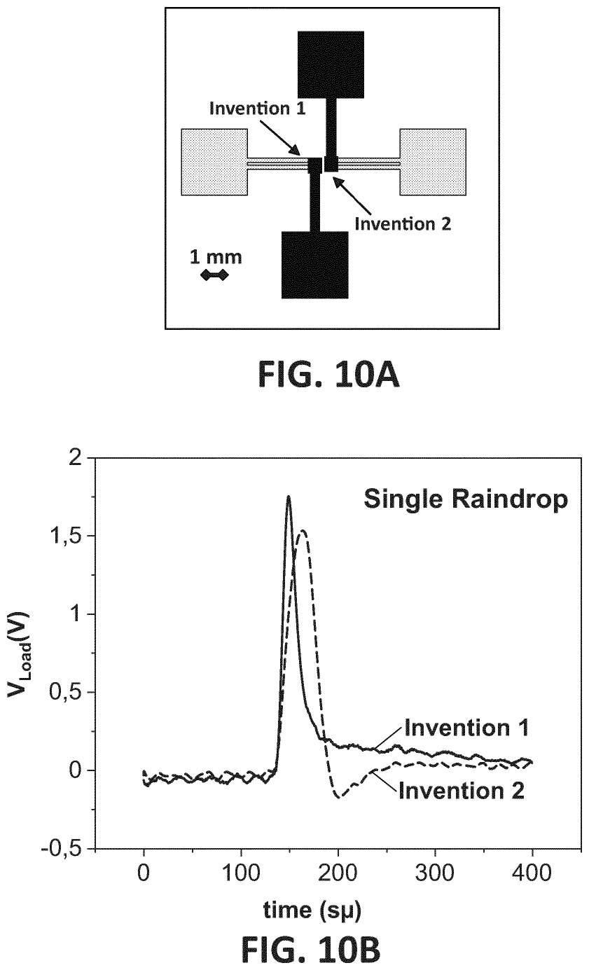

The FIG. 10A shows an embodiment of the invention for a 2×1 array fabricated using silver sub millimiter electrodes and a fluorinated polymer as a triboelectric element. In this case, the instantaneous DC peak voltage generated by each of the inventions is represented in FIG. 10B.

In this FIG. 10B, the 2×1 array of triboelectric generators is contacted by a single raindrop. The instantaneous power generated is a 33% higher than for the equivalent single invention represented in FIG. 9B. This is an indication of the application of the invention for enhancing the energy harvested from a single drop impact event.

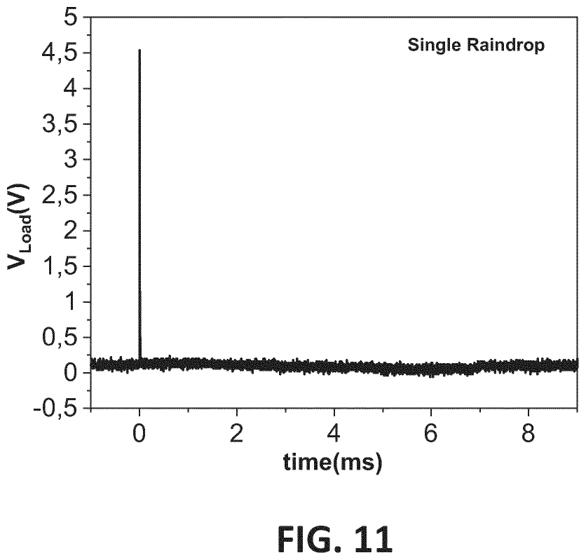

FIG. 11 shows the peak output voltage for rainwater for a freshly charge surface of the invention showing a sharp positive voltage peak and negligible negative counterpart. This is an indication of the application of the invention producing DC voltage peaks. Thus, the small scale of the electrodes comparing with the liquid contact angle provides a single positive pulse with high voltage.

1. An energy harvesting device comprises one or more triboelectric generators (1), each one comprising:
a bottom electrode (2),
at least one friction or triboelectric (3) element layer/foil/plate placed over the bottom electrode which is subjected to an injection or generation of electrical charge, and
at least two exposed top electrodes electrically connected (4) placed over the triboelectric element and defining at least one gap (5) between them,
wherein the gap has a length in the micrometre to submillimetre scale, exposing the triboelectric element is exposed to the external environment and is configured to vary the capacitance of the triboelectric generator defined by top and bottom electrodes (1) when a drop of liquid contacts the two exposed top electrodes and generating voltage peaks in the microsecond to millisecond range.

2. The energy harvesting device according to claim 1, comprising an array of triboelectric generators (1) configured to be arranged one next to the other so that droplets repeatedly bounce and contact multiple triboelectric generators (1).

3. The energy harvesting device according to claim 1, wherein the friction or triboelectric element (3) is hydrophobic or slippery.

4. The energy harvesting device according to claim 1, further comprising one or more substrates (6) placed under the triboelectric generators (1).

5. The energy harvesting device according to claim 4, wherein the substrate (6) is flexible or non-flat.

6. The energy harvesting device according to any of previous claims, wherein each top electrode (4) is smaller than the bottom electrode (2).

7. The energy harvesting device according to any of previous claims, wherein the size of each triboelectric generator (1) ranges in the micrometre to sub-millimetre scale.

8. The energy harvesting device according to any of previous claims, wherein the electrodes (2, 4) can have round, triangular, square or rectangle shape.

9. The energy harvesting device according to any of previous claims, wherein the friction element (3) are charged negatively or positively with the help of charge injection techniques or by natural effects.

10. The energy harvesting device according to any of previous claims, wherein a plurality of triboelectric generators (1) are distributed and fabricated as an array using CMOS (complementary metal-oxide semiconductors), MEMS (microelectromechanical systems), IC (Integrated Circuit), lithography, direct printing and laser patterning processes, or other high yield manufacturing techniques.

11. The energy harvesting device according to any of previous claims, further comprising at least one photovoltaic or thermosolar cell (7) and/or at least one thermoelectric (10), pyroelectric (9), piezoelectric (8) and/or a different triboelectric (11) energy harvester.

12. The energy harvesting device according to claims 4 and 11, wherein the triboelectric generators (1) and the substrates are of transparent materials to allow light to reach the at least one photovoltaic or thermosolar cell (7) and/or at least one thermoelectric (10), pyroelectric (9), piezoelectric (8) or different triboelectric (11) energy harvester.

13. The energy harvesting device according to claims 4 and 11, wherein the substrate is placed on the surface of the bottom electrode not covered by the triboelectric element (3) and over the at least one photovoltaic or thermosolar cell (7) and/or at least one thermoelectric (10), pyroelectric (9), piezoelectric (8) and/or a different triboelectric (11) energy harvester or the substrate is placed below the triboelectric generator, the at least one photovoltaic or thermosolar cell (7) and/or at least one thermoelectric (10), pyroelectric (9), piezoelectric (8) and/or a different triboelectric (11) energy harvester.

14. The energy harvesting device according to claim 13, wherein the transparent materials are conductive oxides, ceramics, hybrid materials, or polymers, graphene or metal meshes for the electrodes (2, 4) and thin layers of polymers, ceramics, hybrid or oxide for the triboelectric element (3).

15. The energy harvesting device according to any of previous claims, wherein the triboelectric generators (1) are configured to be arranged in a sloped position with respect to a horizontal plane.

16. The energy harvesting device according to any of previous claims, further comprising a power management unit which is connected to the triboelectric generators (1) and at least one photovoltaic or thermosolar cell (7) and/or at least one thermoelectric (10), pyroelectric (9), piezoelectric (8) or triboelectric (11) energy harvester.

17. A method for producing DC energy from droplets and liquids by using the energy harvesting device according to any of claims 1 to 15, wherein the triboelectric element (3) is hydrophobic or slippery, the method comprising the steps of:
receiving at least one droplet or liquid on the exposed top electrodes (4);
making an electrical connection between the drop and the top electrodes (4);
varying the capacitance of the triboelectric generator (1); and
generating a positive voltage peak in the microsecond to millisecond range.
